(19) United States
(12) Patent Application Publication
(10) Pub. No.: US 2023/0214852 A1
(43) Pub. Date: Jul. 6, 2023

(54) METHOD AND SYSTEM FOR AUTHENTICATION AND REGISTRATION OF A PRODUCT

(71) Applicants: John Scott ANDREAS, Springfield, OR (US); Andy Pratt HICKEN, Springfield, OR (US)

(72) Inventors: John Scott ANDREAS, Springfield, OR (US); Andy Pratt HICKEN, Springfield, OR (US)

(21) Appl. No.: 18/151,126

(22) Filed: Jan. 6, 2023

Related U.S. Application Data
(60) Provisional application No. 63/297,108, filed on Jan. 6, 2022.

(51) Int. Cl. G06Q 30/018; G09F 3/00; G06K 7/14; G06K 19/07

(52) U.S. Cl. CPC G06Q 30/0185; G09F 3/0297; G06K 7/1404; G06K 19/0723

(57) ABSTRACT

An authentication method and system for authenticating and registering a product which employs an authentication label and a registration label. An authentication label may provide an authentication code for determining a product identification at a remote server. A registration label may provide a registration code for verifying the product registration and/or registering the product. The authentication label and the registration label may be provided as a layered security element, the authentication label being a top layer and the registration label being a bottom layer of the layered security element.

### CROSS REFERENCE TO RELATED APPLICATIONS

This application claims the benefit and priority of U.S. provisional application No. 63/297,108 filed Jan. 6, 2022. The noted priority application is incorporated herein by reference in its entirety.

### TECHNICAL FIELD

The present invention relates generally to methods and related systems for authentication and registration of products by consumers, distributors, retailers, and/or other parties.

### BACKGROUND

The rapid growth of massive e-commerce retailers filled with third-party sellers has revolutionized the way that goods are bought and sold, providing powerful platforms through which sellers can engage large numbers of potential customers from within their own homes. While generally hailed for increasing consumer convenience, the e-commerce model effectively distances products purchased from sellers and has led to a dramatic increase in counterfeit goods, pirated goods, knockoffs, and other phony products sold. In addition to financial losses to affected businesses, this illicit activity threatens public health and consumer confidence.

Consumers desire to be confident in the safety, quality and authenticity of the products that they purchase. As counterfeiting is not a new problem, many methods for deterring counterfeiting or detecting counterfeit products have been developed. One of these is to attach unique codes, such as a Universal Product Code (UPC) to the packaging of a product in order to verify that it was packaged by and is an authentic product from an original producer. Unfortunately, these codes can easily be duplicated, replaced with fraudulent codes, or be removed or damaged thus rendering them ineffective for counterfeit detection. These codes can also be re-used for one or multiple times.

Other systems use tokens such as holographic markers which can be attached to a product or its packaging and can be scanned to verify authenticity. However, these suffer from the same problem as UPCs in that the tag can be forged (albeit with more difficulty) and multiples of the same tag can be scanned and a database is only able to indicate if the code itself is valid or not. Further, these known tags provide no way to distinguish between a product for sale on a shelf versus a product that has been purchased.

Accordingly, there are several deficiencies within the art that can be benefited by technical advancements. The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

A method is provided to facilitate a comparison process in which a product is authenticated and registered. For example, a system performing the method may be configured to scan an authentication code from an authentication label using a user device and transmit an authentication message from the user device to a remote server, the authentication message including the authentication code. The remote server may determine a product identification for the product at the remote server on the basis of the authentication message, the product identification including one of a registered product, an available product, or a counterfeit product, and transmit the product identification to the user device. The user device may scan a registration code from a registration label and transmit a registration message to the remote server, the registration message including the registration code. The remote server may verify the product identification for the product at the remote server on the basis of the registration message, such that the remote server registers the product on the basis of the registration message where the product identification comprises an available product and transmits the product identification to the user device where the product identification includes a registered product or a counterfeit product.

A multilayer security element or tag may be provided including the authentication label and the registration label. In the multilayer security element, the authentication label may be provided as an upper layer and the registration label may be provided as a lower layer. The registration label may be obscured or otherwise covered by the authentication label such that the authentication label must be removed in order to access, read or scan the registration label.

A database is configured to verify the authentication code and the registration code and may further associate the product with a registered owner in various embodiments. The database may include a user identification associated with a given product, records of all scans of the authentication label and/or the registration label for a given product, a list of all unique products that are associated with a specific user, etc. According to one embodiment, the authentication message may comprise a read-only message while the registration message may comprise a write message in the first instance.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings, which are described below.

FIG. 1 illustrates a system for authenticating a product according to embodiments of the disclosure.

FIG. 2 illustrates a security element including an authentication label and a registration label according to an embodiment of the disclosure.

FIG. 3 illustrates a flowchart of a method for authenticating a product according to embodiments of the disclosure.

FIG. 4 illustrates a flowchart of a method for authenticating a product according to another embodiment of the disclosure.

The Appendix includes additional disclosure.

### DETAILED DESCRIPTION

Accurately authenticating products is challenging with available methods and systems. Significant research and work has focused on creating security elements that cannot be replicated, or only with great difficulty, including elaborate chemical compositions and chip integration. In many cases, these technical tools are expensive, cumbersome, and/or limited.

Disclosed methods and systems provide unique solutions to challenges within this technical space. In particular, disclosed methods and systems are able to authenticate products employing both unique scannable or readable authentication and registration labels affixed to products and a remote server with a database to verify scanned codes. To verify authenticity of a product bearing such labels, a user may scan the authentication label and transmit a corresponding authentication code to the remote server. The remote server determines a product identification on the basis of the authentication code, including whether the authentication code is genuine and whether the product has been registered to a user previously. To register an authentic product, the user may scan the registration label and transmit a corresponding registration code to the remote server. The remote server determines whether the registration code is genuine and has never been scanned by another device before. If so, the remote server modifies the product identification to identify the product as registered. Any subsequent registration request with the same registration code or authentication code as a registered product may receive a negative response regarding the authenticity of the underlying product.

As used herein, a “module” comprises computer executable code and/or computer hardware that performs a particular function. One of skill in the art will appreciate that the distinction between different modules is at least in part arbitrary and that modules may be otherwise combined and divided and still remain within the scope of the present disclosure. As such, the description of a component as being a “module” is provided only for the sake of clarity and explanation and should not be interpreted to indicate that any particular structure of computer executable code and/or computer hardware is required, unless expressly stated otherwise. In this description, the terms “component”, “agent”, “manager”, “service”, “engine”, “virtual machine” or the like may also similarly be used.

As used herein, “affixing” to a product includes but is not limited to physical attachment to a product itself, printing directly on a product, insertion inside a product, built into a product, etc. “Affixing” to a product also includes attaching to packaging of a product, including placing inside packaging of a product, or any other way of ensuring that the “affixed” element is not separable from a product without tampering with the product or associated packaging.

While the current application refers to “unique” numbers throughout, the term is not intended to be read so narrowly as to require that every number be positively unique. Rather, the concept is that whatever numbers are used to identify specific mobile devices the overall methodology is capable of differentiating between different products, labels, and devices.

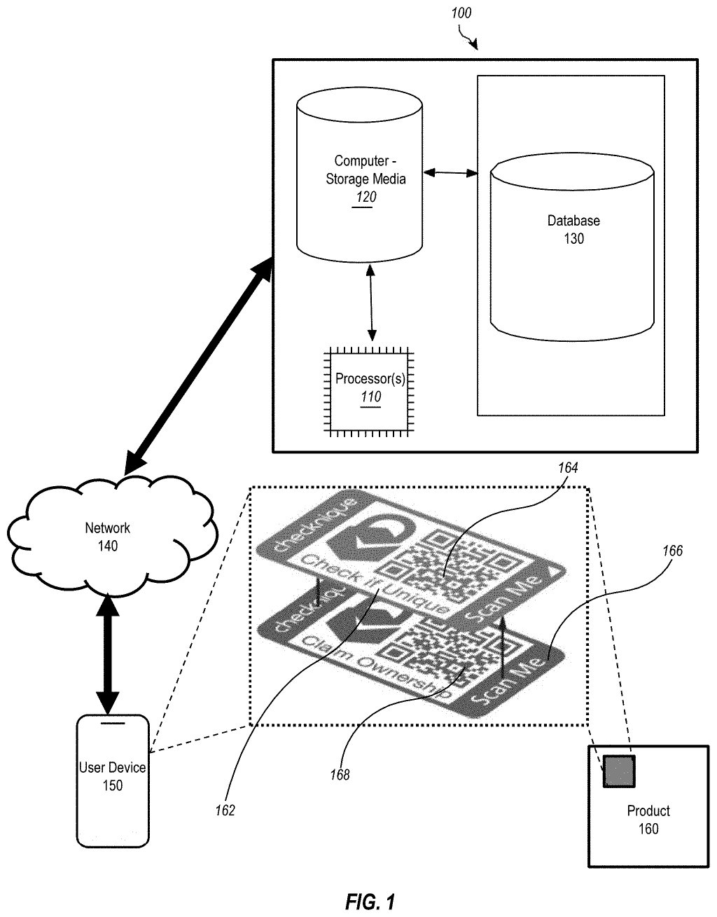

FIG. 1 illustrates an exemplary remote server 100 for managing authentication and registration of products. The depicted remote server 100 may comprise a computer system including one or more processor(s) 110 and computer-storage media 120. The computer-storage media 120 may comprise executable instructions that when executed by the one or more processors 110 may configure the remote server 100 to maintain a database 130 of products and associated information. For example, the database 130 may store, for each product, information such as regarding authenticity of the product, ownership of the product, the manufacturer of the product, etc.

As referenced in FIG. 1, the remote server 100 may be configured to communicate over a network 140 with a user device 150. As used herein, a “user device” may comprise a mobile computing device such as a smart phone, laptop computer, wearable computing device, or similar devices. The network 140 may include a wireless or over-the-air connection, such as may be suitable for communication between a remote server 100 and a user device 150.

FIG. 1 additionally illustrates a product 160 including an authentication label 162 including an authentication code 164 and a registration label 166 including a registration code 168, respectively. The authentication code 164 and the registration code 168 may be unique to the product 160 and associated with the product in the database 130. In one aspect, the authentication code 164 and the registration code 168 may be machine readable or scannable, such as by the user device 150, for transmission to the remote server 100. For example, the authentication code 164 and the registration code 168 may be provided as unique Quick Response codes, barcodes, or similar markings that can contain encrypted or non-encrypted code readable from a surface of the labels 162, 164 for verification through database 130, and/or may be provided as RFID information or NFC information from a corresponding label as would be understood by one skilled in the art from the current disclosure.

The user device 150 may include a scanning or reading device, such as a camera, RFID reader, NFC reader, or similar device for automatically capturing, scanning or reading an authentication code 164 and/or a registration code 168. In one aspect, the user device 150 may include a user interface for receiving input from a user, such as for manual input of an authentication code 164 and/or registration code 168 using a keyboard, touch screen, microphone or related interface.

Verification of the authentication code 164 may comprise identification of the product 160 on the basis of the authentication code 164, including transmission of the product identification to the user device 150. The product identification may indicate to the user device 150 whether the product 160 associated with the authentication code is genuine, is counterfeit, or has already been purchased and registered to a user. Verification of the authentication code 164 may be performed repeatedly, whether or not the product identification has changed, and may comprise a “read-only” operation. As a read-only operation, verification of the authentication code 164 may have no effect on the information related to the product 160 stored in the database 130, although information regarding a verification request may be recorded to form the basis of an administrative action, as is described in greater detail later in the application.

Verification of the registration code 168 may comprise identification of the product 160 and, if the registration code 168 has not previously been scanned, association of the product with a particular user, user device, and/or account. In like manner, the product identification may be updated to indicate that the product associated with the authentication code 164 and/or the registration code 168 has already been purchased and registered to a user. If the registration code 168 has previously been scanned or is not genuine, the product identification may be transmitted to the user device 150 indicating to the user device 150 whether the product 160 associated with the registration code is counterfeit or has already been purchased and registered to a user. The registration code 168 may essentially comprise a single use code, such that the registration code 168 facilitates a single “write” operation in the database 130 and subsequent verification of the registration code 168 comprises a read-only operation.

Some embodiments may require verification of both the registration code 168 and the authentication code 164 for associating the product 160 with a particular user, user device and/or account. For example, verification of the authentication code 164 or the registration code 168 individually may comprise a read-only operation, while combined verification of the authentication code 164 and the registration code 168, at least in the first instance, allows a write operation to the database 130. Combined verification of the authentication code 164 and the registration code 168 may require transmission or scanning of both codes within a predetermined period of time, scanning the codes in the same image, or storage of the codes together in the user device 150 prior to transmission to the remote server 100.

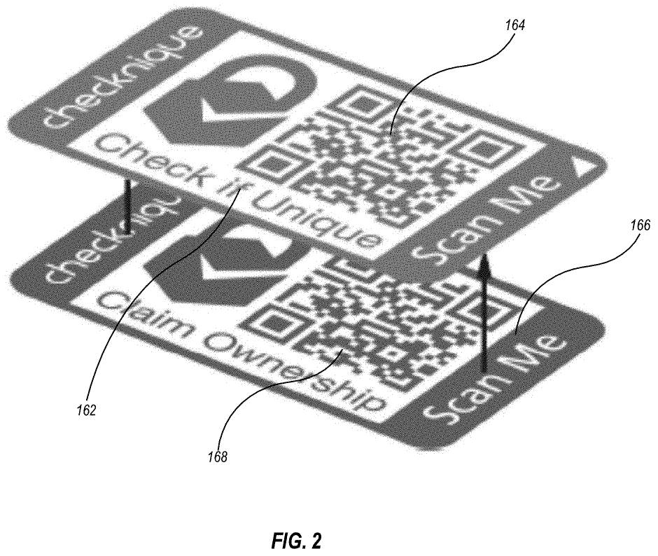

With reference to FIG. 2, according to varying embodiments, a multilayer security element 200 or tag may be provided including the authentication label 162 and the registration label 166. In the depicted embodiment, the authentication label 162 is provided as an upper layer and the registration label 166 is provided as a lower layer. The registration label 166 may be obscured or otherwise covered by the authentication label 162 such that the authentication label 162 must be removed in order to access, read or scan the registration label 166. In some examples, the authentication label 162 and/or the registration label 166 may be provided as adhesive stickers, scratch off layers, or the like. The authentication label 162 and/or the registration label 166 may be affixed directly to the product 160, to product packaging, or may be permanently written, etched, or marked in another fashion directly onto the product 160 itself or the product packaging. In other aspects, the authentication label 162 may be provided on an exterior packaging of the product 160 while the registration label 166 may be provided within the packaging, such that the registration label 166 is generally accessible and/or visible only after purchasing the product 160.

In an embodiment, the authentication label 162 may be affixed to the product in a manner that the authentication label must be removed in order to enable scanning of the registration label 166. In a preferred embodiment according to FIG. 2, removing the authentication label 162 requires destruction of an attachment between the authentication label 162 and the registration label 166 and cannot be repaired. In this way, the authentication label 162 on the product must be tampered with in order to access the registration label 166 and users of the system will thereby be informed that the product 160 has been tampered with. Tampered products can then be reported to the manufacturer to take appropriate action, such as through printing new labels or repackaging the product 160. In some embodiments, only one label may be producible for each authentication code 162 and/or registration code 166, such that the codes may not be replicated and/or reused by nefarious actors.

Embodiments may further require the destruction of the authentication code 164 on the authentication label 162 in order to access the registration label 166 and/or the registration code 168. For example, the authentication code 164 may be scanned and then the authentication label 162 removed in a manner that destroys the authentication code 164, such as by tearing or other destructive removal, in order to facilitate a subsequent scanning of the registration code 168.

In one aspect of the disclosure, the database 130 may maintain a unique product identification for each product 160, such as including a stock keeping unit (SKU), universal product code (UPC), or similar identifier, and may associate each corresponding product with a predetermined authentication code 162 and registration code 166.

In another embodiment, additional information about the product 160 is stored in database 130 and may be provided to the user at the time of scanning the authentication label 162 or the registration label 166 via the user device 150. This information may be used by the user to further ensure the product's authenticity, such as matching the product's serial number, expiration date, appearance, or other attributes of the product to the number, image, or other information transmitted via the remote server 100.

The authentication code 162 and the registration code 166 may be unique to the individual product 160. In some embodiments, the authentication code 162 may comprise a public code, such as a public key of a key pair, and the registration code 166 may comprise a private code, such as a private key of a key pair, identifying the product 160. The database 130 may be configured to associate the product 160 with a registered owner, with a retailer, or with manufacturer information in various embodiments. For identifying a registered owner, the database 130 may include a user identification, such as a mobile identifier identifying the user device 150 e.g., the serial number of a device, Mobile Identification Number (MIN), International Mobile Equipment Identity (IMEI) number, MAC address, and the like. The user identification may be assigned to a user in a previous registration step, such as in a user registering an account for use of an application on their mobile device for performing the method of the application.

In another embodiment, the database 130 may maintain a record of all scans of the authentication label 162 and/or the registration label 166. In one aspect, the database 130 may store a record of the time an/or date information associated with each scan. According to another aspect, the remote server 100 may include a mapping tool which can identify a location of a product 160 at the time of a scan. Through GPS, geotagging, or other location functions, coupled with optional user inputs, the user device may identify a location of a user device at the time of scanning the authentication label 162 and/or the registration label 166 and may store the location information in the database 130.

For example, passive location data from users may be supplied to the remote server 100 in combination with authentication code 164 or registration code 168, to include any one of, or combination of, but not limited to, mobile device country code of a telephone number, Visitor Location Registry (VLR) information of the user device, cellular tower information to which the user device is connected, GPS information, location information determined by networks or any other method of identifying the location where the labels were scanned. From this location, country, market or other information can be determined and, for example if the labels are scanned outside of an intended market, location etc., the remote server 100 can communicate an indication of a non-genuine product or inform the user that the product is being sold illegally in that market or convey some other message. The remote server 100 can also flag suspicious activity and communicate this to system administrators or to manufacturers/retailers of the products.

The database 130 may be configured to maintain a list of all unique products that are associated with a specific user, a specific user device or account. A user may thereby review all unique products that the user has previously purchased and may be provided with additional product information, such as warranty information, advertisements concerning related products, coupons, or the like. In a similar manner, the database 130 may be configured to associate related products 160, such as may be sold by the same retailer etc., for inventory control and/or batch monitoring. As such, treatment of one product may be associated with a product group or batch, for example by identifying suspicious activity related to a single product and associating the activity with an entire product group that may be similarly compromised.

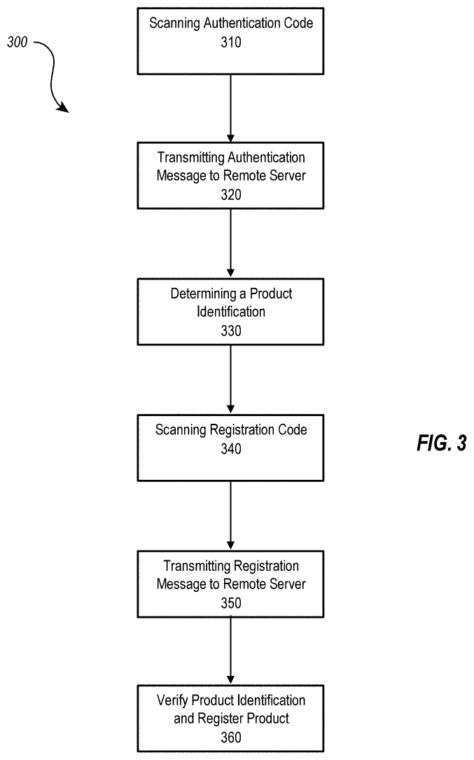

FIG. 3 illustrates a flowchart of a method 300 for authenticating a product and registering ownership of the product. Method 300 includes scanning an authentication code from an authentication label using a user device, the authentication label affixed to the product 310. The authentication code may be provided as a QR code, a barcode, RFID information, NFC information or the like, and may comprise a unique public code, such as a public key of a key pair, or a similar identifier or code associated with the individual product. An authentication message may be transmitted from the user device to a remote server at step 320, the authentication message including the authentication code. The authentication message may further include information regarding the user or the user device and may be transmitted via an application or software associated with the remote server or via a web-based application or page.

In step 330 the remote server may determine a product identification for the product on the basis of the authentication message, such as by accessing a related database containing the information. The product identification may include information relating to the unique product associated with the authentication code, such as identifying the product as one of a registered product, an available product, or a counterfeit product. The product identification may be transmitted to the user device to provide information to a user.

Step 340 may comprise scanning a registration code from a registration label using the user device, the registration label affixed to the product. The registration code may be provided as a QR code, a barcode, RFID information, NFC information or the like, and may comprise a unique private code, such as a private key of a key pair, or a similar identifier or code associated with the individual product. The method further comprises step 350, including transmitting a registration message from the user device to the remote server, the registration message including the registration code. According to varying embodiments, the registration message may further include the authentication code and/or a user identification.

At step 360, the remote server may verify the product identification for the product on the basis of the registration message. Accordingly, the remote server may register the product on the basis of the registration message where the product identification comprises an available product and transmit the product identification to the user device where the product identification includes a registered product tag or a counterfeit product tag.

Some embodiments of the disclosure may require verification of both the registration code 168 and the authentication code 164 for associating the product 160 with a particular user, user device and/or account. For example, verification of the authentication code 164 or the registration code 168 individually may comprise a read-only operation, while combined verification of the authentication code 164 and the registration code 168, at least in the first instance, allows a write operation to the database 130. Combined verification of the authentication code 164 and the registration code 168 may require transmission or scanning of both codes within a predetermined period of time, scanning the codes in the same image, or storage of the codes together in the user device 150 prior to transmission to the remote server 100.

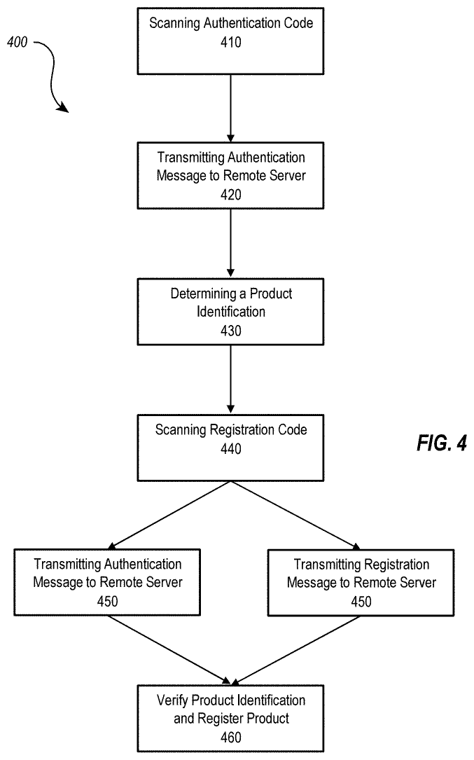

FIG. 4 illustrates an example of a method 400 for authenticating a product and registering ownership of the product with combined verification of the authentication code 164 and the registration code 168. As in the embodiment of FIG. 3, method 400 includes authenticating a product through scanning an authentication code from an authentication label using a user device, the authentication label affixed to the product 410. As previously discussed, the authentication code may be provided as a QR code, a barcode, RFID information, NFC information or the like, and may comprise a unique public code, such as a public key of a key pair, or a similar identifier or code associated with the individual product. An authentication message may be transmitted from the user device to a remote server at step 420, the authentication message including the authentication code. The authentication message may further include information regarding the user or the user device and may be transmitted via an application or software associated with the remote server or via a web-based application or page.

In step 430 the remote server may determine a product identification for the product on the basis of the authentication message, such as by accessing a related database containing the information. The product identification may include information relating to the unique product associated with the authentication code, such as identifying the product as one of a registered product, an available product, or a counterfeit product. The product identification may be transmitted to the user device to provide information to a user, in other words authenticating the product.

However, in contrast to the sequential authentication of a product and ownership registration of the product as in FIG. 3, the embodiment of FIG. 4 requires the use of both an authentication message and a registration message in order to register the product. For this purpose, step 440 may comprise scanning a registration code from a registration label using the user device, the registration label affixed to the product. The registration code may be provided as a QR code, a barcode, RFID information, NFC information or the like, and may comprise a unique private code, such as a private key of a key pair, or a similar identifier or code associated with the individual product. The method further comprises step 450, including transmitting a registration message from the user device to the remote server, the registration message including the registration code and the authentication code. According to varying embodiments, the registration message may further include a user identification.

At step 460, the remote server may determine a product identification for the product on the basis of the authentication message, such as by accessing a related database containing the information, and verify the product identification for the product on the basis of the registration message. Accordingly, the remote server may register the product on the basis of both the authentication message and the registration message, where the product identification comprises an available product, and transmit the product identification to the user device where the product identification includes a registered product tag or a counterfeit product tag.

In varying embodiments, registration of the product may require that the authentication code and the registration code be scanned by the same entity or user in order. For example, the remote server may retain the last user identification that scanned a given authentication code and require that the same user identification as the last user identification scan and present the registration code for a registration of the product to occur. This arrangement advantageously requires the presentation of three unique identifiers in a specific order, preventing brute force or randomized attempts to register products without authorization. Even if a bad actor was to obtain one of the authentication or registration codes, registration would be prevented absent use of the other code in an uninterrupted sequence with the same user identification.

Combined verification of the authentication code 164 and the registration code 168 may require transmission 450 or scanning 410, 440 of both codes within a predetermined period of time, scanning 410, 440 the codes in the same image or from the same geographic location, storage of the codes together in the user device 150 prior to transmission 450 to the remote server 100, or manipulation of one or both of the codes based on the other prior to transmission 450 to the remote server 100.

It should be noted that, while described as discrete steps, varying embodiments may include iteratively scanning and/or transmitting data in any order.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for authenticating a product and registering ownership of the product, the method comprising:
scanning an authentication code from an authentication label using a user device, the authentication label affixed to the product;
transmitting an authentication message from the user device to a remote server, the authentication message including the authentication code;
determining a product identification for the product at the remote server on the basis of the authentication message, the product identification including one of a registered product, an available product, or a counterfeit product;
transmitting the product identification from the remote server to the user device;
scanning a registration code from a registration label using the user device, the registration label affixed to the product;
transmitting a registration message from the user device to the remote server, the registration message including the registration code;
verifying the product identification for the product at the remote server on the basis of the registration message,
the remote server registering the product on the basis of the registration message where the product identification comprises an available product, and
the remote server transmitting the product identification to the user device where the product identification includes a registered product or a counterfeit product.

2. The method as recited in claim 1, wherein the authentication code is a public code and the registration code is a private code.

3. The method as recited in claim 1, wherein the registration code is a single use code.

4. The method as recited in claim 1, wherein the user device is a mobile device.

5. The method as recited in claim 1, wherein the authentication label and the registration label comprise a layered security element, the authentication label comprising a top layer of the layered security element and the registration label comprising a bottom layer of the layered security element, such that the authentication label covers the registration label.

6. The method as recited in claim 5, wherein the authentication label and the registration label are adhesive labels.

7. The method as recited in claim 5, wherein the authentication label and the registration label include RFID elements.

8. The method as recited in claim 5, wherein the authentication label and the registration label are connected together via a single use attachment.

9. The method as recited in claim 1, wherein, prior to scanning the registration code from the registration label, the authentication label is removed from the product.

10. The method as recited in claim 9, wherein the authentication label is destroyed when it is removed from the product.

11. The method as recited in claim 1, wherein registering the product on the basis of the registration message comprises replacing the available product with the registered product in the product identification.

12. The method as recited in claim 11, wherein registering the product on the basis of the registration message comprises recording a user identification with the product identification in the remote server.

13. The method as recited in claim 1, wherein the authentication message is a read-only operation and the registration message is a write operation.

14. The method as recited in claim 1, wherein the registration message includes the authentication code and the registration code.

15. The method as recited in claim 1, wherein the registration message includes the registration code and a user identification.

16. A computer-implemented system for product authentication and registration, comprising:
a remote server comprising at least one processor configured to generate an authentication code and a registration code, the authentication code and the registration code each uniquely, pre-associated with a product of trusted origin;
a database coupled to the remote server and storing product information the authentication code and the registration code;
an authentication label affixed to the product or a corresponding package, the authentication label including the authentication code;
a registration label affixed to the product or the corresponding package, the registration label including the registration code; and
said at least one computer processor of said remote server being further configured to:
receive an authentication request from a user device, said authentication request comprising the authentication code scanned from the authentication label by the user device;
determine a product identification for the product on the basis of the authentication request, the product identification including one of a registered product, an available product, or a counterfeit product;
transmitting the product identification to the user device;
receive a registration request from the user device, said registration request comprising the registration code scanned from the registration label by the user device;
verifying the product identification for the product on the basis of the registration request, by:
registering the product on the basis of the registration message where the product identification comprises an available product, and
transmitting the product identification to the user device where the product identification includes a registered product or a counterfeit product.

17. The system according to claim 16, wherein the authentication label and the registration label comprise a layered security element, the authentication label comprising a top layer of the layered security element and the registration label comprising a bottom layer of the layered security element, such that the authentication label covers the registration label.

18. The system according to claim 16, wherein registering the product on the basis of the registration message comprises replacing the available product with the registered product in the product identification.

19. The system according to claim 18, wherein registering the product on the basis of the registration message comprises recording a user identification with the product identification in the remote server.

20. The system according to claim 19, wherein the user identification comprises a mobile identifier identifying the user device.
